(19) United States
(12) Patent Application Publication
(10) Pub. No.: US 2019/0287150 A1
(43) Pub. Date: Sep. 19, 2019

(54) Customized Textile Measuring, Ordering, and Manufacturing System

(71) Applicant: BRADFORD K. ANGER, Barrington, RI (US)

(72) Inventor: BRADFORD K. ANGER, Barrington, RI (US)

(21) Appl. No.: 16/354,089

(22) Filed: Mar. 14, 2019

Related U.S. Application Data
(60) Provisional application No. 62/643,003, filed on Mar. 14, 2018.

(51) Int. Cl. G06Q 30/06; G06F 16/95; G06F 16/2457; G06F 16/242; G06F 16/28; G06F 17/17; G06T 7/62

(52) U.S. Cl. CPC G06Q 30/0621; G06Q 30/0643; G06F 16/95; G06T 7/62; G06F 16/2428; G06F 16/284; G06F 17/17; G06F 16/24573

(57) ABSTRACT

A system and method for the creation and distribution of custom tailored athletic wear is shown. The system employs the use of a body imaging scan in order to quickly determine measurements of the dimensions of a user to be fitted for the custom athletic wear. The scan is non-invasive, and may be performed on-location at sporting events, meets, practices, and retail locales. Measurement data obtained via the scan is stored on a server computer within a relational database, and is linked to an account created by the user to facilitate the selection of desired custom clothing. A web platform, as well as a mobile device application, enables the user to easily browse available athletic wear, and customize options according to the team name, number, logo, or other personalization options of the user. Manufacturers employ the web platform to select orders that have been placed via the system for fulfillment.

This application is a non-provisional patent application of provisional patent application No. 62/643,003, filed on Mar. 14, 2018, and priority is claimed thereto.

### FIELD OF THE PRESENT INVENTION

The present invention relates to a method of crafting tailored textiles such as shirts and pants, and more specifically relates to the implementation of a digital body measuring device employed at or in sporting events, within the home, and at sport-related facilities to facilitate the collection of sizing data to expedite the manufacturing of tailored textiles produced for individuals. The method caters to the creation of a brand via serving the end user one custom sized, single unit at a time, referenced as n=1 production.

### BACKGROUND OF THE PRESENT INVENTION

Athletic sports continue to gain popularity both in the United States and abroad. As their popularity increases, more individuals are in need of custom-tailored athletic wear that is suitable for comfortable use during races, sporting events, games, practices, and physical therapy sessions. Unfortunately, the present process by which custom athletic wear is produced is generally expensive and cumbersome, which leaves many athletes unable to afford custom-tailored clothing that is designed according to their unique measurements. The cost of customized jerseys alone, equipped with player number and team name is often expensive for a coach, let alone with the option of custom-tailored sizing. A portion of the expense in crafting such custom athletic wear is derived from the cost of visiting a tailor to obtain measurements, and then amending the manufacturing process in accordance with the measurements, or making the adjustments by hand to previously crafted athletic wear.

The common sizes of ‘Extra Large,’ ‘Large,’ ‘Medium,’ ‘Small,’ and ‘Extra Small’ leave many users with clothing that simply does not fit correctly. This can leave many athletes uncomfortable, which can compromise performance during an event such as a game or a race. More affluent and serious athletes often opt for more expensive, custom tailored athletic wear to ensure comfort and confidence during events. If this equipment was more readily available for all participants, each athlete could enjoy the comfort of custom athletic wear. If body scans were employed at the site of athletic and sporting events, the process of crafting such athletic wear could be streamlined and expedited, helping to lower costs, and making custom athletic wear more accessible to all participants.

Additionally, many stores selling athletic wear rarely offer options relating to the customization of the physical appearance of their selection. For instance, at brick and mortar stores, options rarely extend outside of a slim selection of color options, as well as general size options, and are often limited to the stock kept on-hand. Online retail stores often offer more color options, as well as the ability to add custom numerals, logos, team names, and other additions, but customization fails to extend to the sizing dimensions of the clothing. If there were a means by which individuals may be scanned to rapidly acquire their measurements accurately and painlessly, customized clothing would be more accessible to the end consumer, as well as less expensive. Additionally, via data aggregation, if such a scanner were employed to scan a large number of individuals, the data could be used to size users to clothing with mobile devices independently based on a predictive scale algorithm.

Thus, there is a need for a method and system by which an individual may be quickly and easily measured via a scan in order to determine the measurements of the individual on-the-spot, instantly, without a lengthy or intrusive process of measuring by hand. Such a system will facilitate the creation of custom textiles that are crafted in accordance with the measurements of the individual in order to achieve a custom fit. Such a system is preferably configured to enable the user to add numerals, logos, insignias, team names, and other customizations via a web-based platform and/or mobile device application in order to provide the ultimate customized professional athletic wear for the end user. It is envisioned that, with extended use of such a scanning method, data of a large sample size will be aggregated, increasing the efficiency of the scans. Eventually, with enough aggregated data of measurement scans, sizing may be extrapolated even cheaper, such as with a mobile device within the home to facilitate creation of the custom textiles.

The notion of customized athletic wear equipped with customized colors, prints, and those that are made-to-measure should not be taken for granted. The current retail market offers little in this regard, as the mere cost to stock numerous colors is high. If the system and method of the present invention can be adopted by the sports shop, the Adidas™ or Nike model can be severely disrupted. If the method of the present invention may be adopted by such large manufacturers, the customization process may be expedited and streamlined.

While it is known that corporations such as Amazon™ are investigating the use of customized clothing that is made ‘on-demand’ for the consumer, the system by which this is implemented relies on the user furnishing his or her own measurements manually, and does not employ the scanning system of the present invention to enhance and expedite customization of clothing. Many consumers may be unable or unwilling to measure themselves properly, so any amount of virtual representation, via an avatar or otherwise, on a computer is more likely to be misleading, unlike the solution provided by the system of the present invention.

While much thought has gone into importing textiles form overseas and delivering the product to the end user, 42% of garments purchased online are rejected due to size issues. This represents a cost of 65 billion USD to Amazon™. The present invention addresses a process configured to reduce this rejection rate. The present invention interprets raw data obtained via a body scan to craft textiles custom to the user, such that the number of articles produced is only the amount needed (n=1).

### SUMMARY OF THE PRESENT INVENTION

The present invention provides a method by which custom fitness clothing and gear may be crafted for the end user based on a rapid, non-invasive body scan, facilitating custom tailored clothing for the end user. The body scan is configured to map the body of the user, in the process obtaining sensitive measurements relating to the dimensions of the end user. Ideally, the scanning process of the present invention takes less than one second to conduct, and is preferably performed at or near sport events such as races, triathlons, decathlons, cycling races, team sports meets, soccer games, lacrosse games, or at the location of other similar sport activities. It is envisioned that gyms and specialty fitness shops may be equipped with the scanner of the present invention in order to facilitate orders placed through the mobile device application or web interface of the present invention. Scanned data is aggregated after many scans are completed.

The goal of the system and method of the present invention is to accumulate data on athletes using scanners, as well as via software-based methods developed for “event” type registration processes. The accumulated data is preferably displayed in a “Netflix-styled” list or queue environment. However, instead of TV shows, the present invention facilitates the creation and sale of various forms of “performance wear for the serious athlete.” The system of the present invention preferably employs a web platform on which customer accounts may be created by users online, and purchases may easily be made. As such, use of the method and system of the present invention facilitates the creation of unique ‘brands’ to be sold on custom-made websites. The customer's data is preferably stored in a relational database on a secured server, which is accessible via the mobile device application or the web platform of the present invention. The scans, and the inherent measurements derived from the scans, are accessible to the athlete. The system of the present invention intends to make sales within these accounts. The method of the present invention guarantees that the production of products manufactured and sold via factories are solely from factories owned or certified in the method of production that is needed to make fitted clothing from a scan. Preferably, the manufacturing plants are preferably required to meet strict compliance regulations.

In short, the perfect fit for a specific end user, obtained via the system and method of the present invention, is determined by an assortment of factors. In-depth and careful study of the characteristics of the fabric used are critical to the correct functioning of the present invention in creating correctly sized textiles. The fabric coefficients are tested in respect to the sport that the end user will be performing. That is, the fit of a garment depends on how, where, and how much fabric is applied when assembling the final garment. Use of the system and method requires careful study of all fabrics that are to be used in the method. In order make a perfect fit for a specific end use by a specific end user, perfect measurements of the body are required.

The present invention employs specially designed software that extracts size measurements through body scanning technology. The software cooperates with numerous branded fixed-position scanners, as well as hand-held body scanners. The present invention facilitates the extraction of body measurements from scan systems that are available publicly. To guarantee the measurements are accurate, the system and method requires the partner companies to employ scanning hardware systems compatible with the software employed by the present invention.

For bodies that cannot be scanned for any reason, the system the relies on a photo application such as “FotoToFit™,” a software as a service (SaaS) solution in collaboration TOZmart™, which employs Artificial Intelligence (AI) technology to recognize the human body from digital photographs of the front and side of a user. From there, the software predicts the human body form and key measurements. The software uses statistical modeling and probability to gather the measures needed to make a perfect fit.

In order to make a paper pattern (blueprint for a garment's size) the system preferably employs a pattern-on-demand software platform that takes the above points into account while allowing the automation of making patterns from a “fit model.” The software computes all aspects of the textile from the measurement data, and outputs the pattern to be used to cut the fabric to be later put together to result in the ordered garment.

### BRIEF DESCRIPTION OF THE DRAWINGS

The present invention will be better understood with reference to the appended drawing sheets, wherein:

FIG. 1 exhibits a flow chart depicting the method of the present invention as it applies to the end user in terms of crafting custom athletic wear.

FIG. 2 depicts a chart detailing the inner workings of the system and method of the present invention, showing the interconnection of various companies, scanners, and services required to effect the creation of a garment/clothing brand using n=1 manufacturing.

### DETAILED DESCRIPTION OF THE PREFERRED EMBODIMENT

The present invention is a method and system for creating custom athletic textiles such as jerseys, shirts, shorts, spandex/football pants, jogging attire, etc. based on aggregated sizing data. The method of the present invention employs the use of a scanner disposed in communication with a scanner computer. Both the scanner and the scanner computer are preferably available on-location at sporting events such as races, games, exhibitions, trade shows, athletic sports stores, and similar locations. The scanner is preferably equipped with 12 (or more) optical lenses, as well as LED lights, which are controlled by the scanner computer. The scanner is configured to capture raw measurement data from a user upon passing through the scanner. A second computer is preferably disposed to process the raw (binary) data provided by the scanner computer. A scan capture via the scanner of the present invention takes approximately 0.5 second. Processing the data from the scan via the second computer takes approximately three minutes. Once processing has begun on the second computer, the scanning computer is free to conduct a new scan via the scanner (for the next user wishing to be scanned for the sizing of customized athletic wear). Processed data is preferably sent to a relational database stored on a secured server computer that is accessible via a mobile device application and a web platform of the present invention. Other embodiments of scanner hardware may be configured for home use to facilitate self-scanning. Similarly, measurements obtained via a series of detailed photographs may be employed for bodies that may not be scanned for any reason.

After a user has been scanned, and the raw data has been processed by the second computer, the user is prompted to create a user account. Account creation is preferably facilitated via the mobile device application or the web platform of the present invention. A link to the web platform and/or mobile device application is provided to the scanned user after the scan has been completed. Upon the creation of an account by the user, preferably including the user's name and address, the measurement data obtained from the raw data of the scan is linked to the account of the user. At this point, the user is free to browse the selection of available athletic wear options for purchase via the web platform or mobile device application. Unlimited color options are preferably available, and the user is provided the option to upload or create a logo, insignia, team name, player number, or other print to further customize his or her order. The system of the present invention includes a purchasing system via mobile device application and web-based interface which puts the factory in the hands of the end user, shop, or even team coaches.

The scanning system of the present invention is preferably configured to employ a form of machine learning with which the inherent process of manufacturing for unique individuals becomes more efficient and expedient over time. As the system of the present invention accumulates scanned data from one person to the next, the data pool will increase. For example, if there are 1000 scans of users, the 1001 scan will fall within one of the 1000 individuals previously scanned wherein all measurements match within margin of 2 cm. In such instances, the pattern maker employed by the manufacturer will not need to recreate a new pattern. We only need to produce base on this match. If the scanned data is not a match with a previous scan, the unmatched data is saved on file within the relational database for comparison for use after the next scan. Seven key measurements are preferably compared in order to obtain an accurate sizing of any given individual user.

It should be understood that, via the online platform of the present invention, the user may be depicted on a display of the computer or mobile device accessing the platform, such that the user may virtually ‘try-on’ selected articles of clothing prior to purchase (and manufacturing) of the customized textile. The user may be prompted to upload a photo of his or herself to facilitate virtual mapping of the selected textiles to appear on a virtual embodiment of the user. Via sharing an image of the user, the user may permit the use of his or her measurement data for future use. Namely, in future uses, aggregated data, including that of the user, may be employed to expedite and facilitate the creation of customized textiles without the need for the use of the initial body scanner. In lieu of use of the body scanner, future users of the system and platform of the present invention are able to employ a sensitive camera, and/or an inexpensive sensor for use with a mobile device, to obtain measurement data of the user within the comfort of the home of the user. Additionally, it should be understood that the user is preferably presented with a variety of manufacturers which are equipped to interpret and employ the measurement data for the manufacturing of custom textiles. A list, drop-down menu, or similar selection mechanism may be made available via the online platform of the present invention.

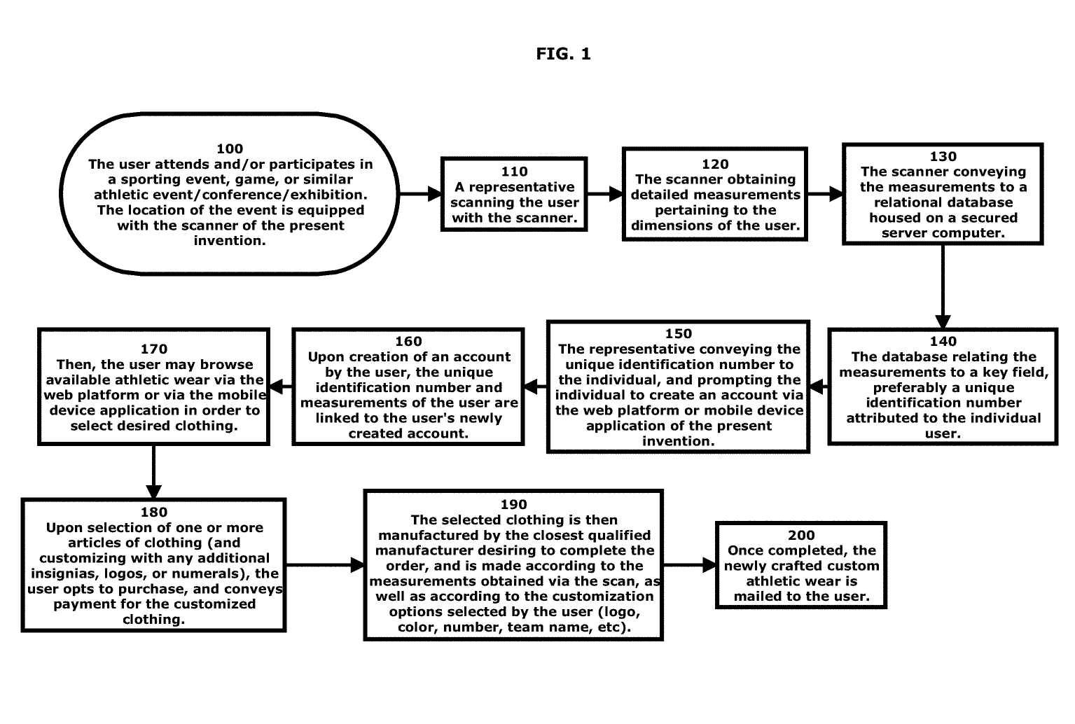

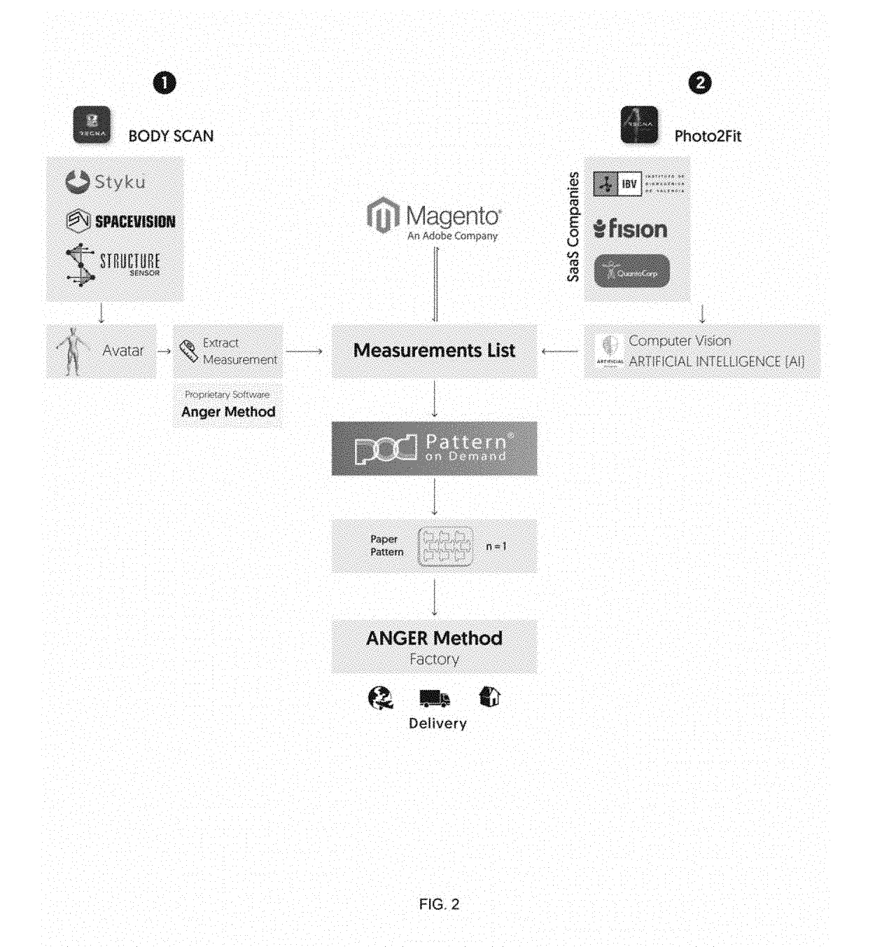

The process of installation and use of the present invention, as depicted in FIG. 1, is preferably as follows:
1. The user attends and/or participates in a sporting event, game, or similar athletic event/conference/exhibition. The location of the event is equipped with the scanner of the present invention. (100) Alternately, the scanner may be disposed within an athletic wear store, sporting goods store, cycling facility, physical therapy facility, or similar location. Alternately, the user may be scanned at his or her home, or may employ a photo service to highly approximate the results of a physical scanner with home photo technology such as that found within a conventional smartphone using FotoToFit™ Software or similar SaaS solution as shown in FIG. 2.
2. An individual scanning the user with the scanner. (110)
3. The scanner obtaining detailed measurements pertaining to the dimensions of the user. (120)
4. The scanner conveying the measurements to a relational database housed on a secured server computer. (130)
5. The database relating the measurements to a key field, preferably a unique identification number attributed to the individual user. (140)
6. The representative conveying the unique identification number to the individual, and prompting the individual to create an account via the web platform or mobile device application of the present invention. (150) Account creation preferably entails providing a full name and address of the user; however additional information may be requested during account creation. Account creation is preferably facilitated on-site, but may be completed at home if the user chooses. The user uploads a picture of his or herself to complete account creation. The picture may be used such that the user may virtually ‘try-on’ the clothing selected by the user.
7. Upon creation of an account by the user, the unique identification number and measurements of the user are linked to the user's newly created account. (160)
8. Then, the user may browse available athletic wear via the web platform or via the mobile device application in order to select desired clothing. (170) Clothing shown as available for creation (custom fit) and purchase are shown to the user. From the application, users may manipulate their textile offer to meet their needs. Styles and color may be selected within the application or web platform according to the preference of the user, and shown to the user after selection as a preview. Logos, numbers, or other team insignias may be supplied by the user via an uploaded image via the mobile device application or web platform to be included on selected athletic wear.
9. Upon selection of one or more articles of clothing (and customizing with any additional insignias, logos, or numerals), the user opts to purchase, and conveys payment for the customized clothing. (180) Alternately, the user may save the order and choose to return to complete the purchase at a later date.
10. The selected clothing is then manufactured by the closest qualified manufacturer desiring to complete the order, and is made according to the measurements obtained via the scan, as well as according to the customization options selected by the user (logo, color, number, team name, etc.). (190) Manufacturers unable or unwilling to take the order are not mandated to take on the order. The order remains in a queue until a manufacturer takes the order/contract. Manufacturers may only be eligible to take orders if they have met strict quality control guidelines, and are equipped to make use of the input measurements derived from the body scan of the user.
11. Once completed, the newly crafted custom athletic wear is mailed to the user. (200) In the event that the received athletic wear is not consistent with the dimensions of the individual, a refund may be issued.

It should be understood that the method of the present invention also empowers Coaches or other interested parties to supply end users with their own branded clothing quickly and easily using the system. Additionally, the data obtained via scans may be calibrated to fit physical therapy offices to make clothing for “training and recovery” needs using the system and method of the present invention.

Later embodiments of the present invention are preferably configured to employ the aggregated data of thousands of users to construct predictive algorithms which may then be used to expedite and facilitate the mapping of measurement data to new users of the system of the present invention. Later users of the system may make use of prior users' sizing data to extrapolate similar sizing data of a new user based on an uploaded photo taken with specific specifications (such as distance from the user, coloration, brightness, image quality, etc.) Through such a system, users may be effectively measured against prior users without the need for a physical body scanner through the use of detailed images of the user instead. As such, it should be noted and understood that the data obtained via the body scans of thousands of users is to be saved to the database, and employed to sharpen and expedite the creation of additional measurement data via a sizing extrapolation algorithm.

A web page may be created for the “Brand” (i.e. new product line by a company or interested individual) that describes their offer in detail. In this web page, the n=1 customer or end user (once scanned) is “hosted’ and given the opportunity place orders. The people which have been scanned are given a short profile that they can use to place orders at any time. The building of the web porthole, the order process, logistic to deliver products, money management and customer services is performed via the method of the present invention. In contrast, the partner company using the process of the present invention should be focused on sales and marketing, rather than building the garments, shipping the garments, order execution, etc.

It should be understood that the present invention offers a “plug and play” process to individuals that wish to build a “brand”. The method allows a brand to target a specific athlete to which they wish to sell sports apparel. The method is built to serve the end user one-size, one-unit (garment) at a time, referenced as n=1 production.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for creating a clothing brand suitable to the creation and sale of custom-tailored garments to end users comprising:
obtaining precise measurements of the body of an end user;
conveying the measurements to a relational database;
wherein the relational database is housed on a secured server computer;
the database relating the measurements to a key field, attributing a unique identification number to the end user;
conveying the unique identification number to the end user;
the end user creating an account on a web page interfaced with the relational database;
wherein the account includes a user profile;
the end user uploading at least one photo of his/her self to the website, adding the at least one photo to the user profile;
the end user entering the unique identification number to a profile of the end user on the web page, linking the unique identification number to the profile of the end user;
the end user shopping for custom-tailored garments on the web page;
the end user selecting a custom-tailored garment on the web page which exhibits the colors and features desired;
the web page displaying a virtual preview of the selected custom-tailored garment to the end user depicted overlaid onto the at least one photo;
the end user customizing the selected custom-tailored garment with at least one of the following: insignias, logos, numerals;
the end user purchasing the selected custom-tailored garment by conveying payment information to the web page;
the secured server computer of the web page processing the payment information;
a qualified manufacturer manufacturing the selected custom-tailored garment in accordance with the body measurements and customizations of the end user only after the payment is received; and
the qualified manufacturer mailing the selected custom-tailored garment directly to the end user.

2. The method of claim 1, wherein the precise measurements are obtained via a body scanner.

3. The method of claim 1, further comprising:
obtaining the precise measurements via taking at least two photographs of the end user;
uploading the at least two photographs to the secured server computer; and
employing a Software-as-a-Service (SaaS) platform to extrapolate the measurements of the end user from the at least two photographs.

4. The method of claim 1, further comprising:
comparing the precise measurements of the end user against those of other previously obtained measurements from other end users with a predictive algorithm; and
extrapolating similar sizing data of new end users based on an uploaded photograph taken with specific specifications, the specifications including at least one of the following: distance of camera from the user, coloration of the photograph, brightness of the photograph, image quality of the photograph.

5. The method of claim 1, wherein the web page only displays custom-tailored garments to the end user which are presently available for manufacturing based on the precise measurements of the end user.

6. The method of claim 1, further comprising:
the end user uploading at least one picture of at least one of the following to the secured server computer for placement onto the custom-tailored garment during manufacturing: logos, insignias, numbers.

7. The method of claim 2, further comprising:
comparing the precise measurements of the end user against those of other previously obtained measurements from other end users with a predictive algorithm; and
extrapolating similar sizing data of new end users based on an uploaded photograph taken with specific specifications, the specifications including at least one of the following: distance of camera from the user, coloration of the photograph, brightness of the photograph, image quality of the photograph.

8. The method of claim 3, further comprising:
comparing the precise measurements of the end user against those of other previously obtained measurements from other end users with a predictive algorithm; and
extrapolating similar sizing data of new end users based on an uploaded photograph taken with specific specifications, the specifications including at least one of the following: distance of camera from the user, coloration of the photograph, brightness of the photograph, image quality of the photograph.
